(19) United States
(12) Patent Application Publication
(10) Pub. No.: US 2005/0028120 A1
(43) Pub. Date: Feb. 3, 2005

(54) Method and software for automatically designing IC layout

(75) Inventors: Tsang-Chi Kan, Taipei (TW); Chun-Wei Huang, Taipei (TW)

Correspondence Address: BRUCE H. TROXELL, SUITE 1404, 5205 LEESBURG PIKE, FALLS CHURCH, VA, 22041, US

(73) Assignee: Ali Corpotation

(21) Appl. No.: 10/829,967

(22) Filed: Apr. 23, 2004

(30) Foreign Application Priority Data
Aug. 1, 2003 (TW) 92121074

(51) Int. Cl. G06F 17/50

(52) U.S. Cl. 716/8; 716/12

(57) ABSTRACT

A method and software for automatically designing IC layout can be used in the two phases of IC circuit design-and-layout and the circuit simulation. Users can assign all or the partial end points of the devices in the integrated circuit to connect plural metal layers by this manner of automatic layout. In such a way, it is only necessary to make the connection lines connect the end points in the certain metal layers without connecting to the first metal layer. Moreover, circuit modification can be achieved more easily and time and cost saving

### FIELD OF THE INVENTION

The invention relates to a method and software for automatically designing IC layout, and in particular, to a method and software for automatically designing IC layout, by which users may assign the end points of the circuit devices and connect the inter metal layers.

### BACKGROUND OF THE INVENTION

Following the development of technology, people have more restrict requirement of the characteristics of compactness of communication products, such as cellular phone, or mobile products, such as personal digital assistant (PDA), so the application of the integrated circuit (IC) are becoming popular and widely used. Integrated circuit is a manner that may make a circuit structured as three-dimensional configuration to reduce its application area, so integrated circuits are found in various applications.

Please refer to FIG. 1, which shows a design flowchart of integrated circuit. Same as the design of ordinary software, a source code is first written and then compiled by a compiler to become an executable state, but it is scarce for a program that may fulfill the objective of the designer at its first execution. First, the designer has to design the circuit according the requirement and connect the layout of the relative elements. Afterwards, by means of a computer, the circuit is simulated to find out any mistaken connection or inappropriate design and then make correction. After repetitious simulations to make sure that there is no problem and the design objectives are fulfilled, a procedure of tape out is proceeded. “Tape out” means to deliver the designed circuit to a wafer manufacturer to process production. Next, the taped out products are taken back for actual test to verify the circuit characteristic of the chip, and the testing results are used to check if the design objectives are fulfilled. If the design objectives are not fulfilled or there is any drawback, then go back to design phase to make modification; if the design objectives are fulfilled and there is no any drawback, then the chip may be produced according to the circuit design.

However, the correction fee of the taped out product is very expansive. Please refer to FIG. 2, which shows a circuit modification illustration of a traditional integrated circuit. The integrated circuit includes a substrate, on which many circuit elements, such as: FET, CMOS, etc. and plural metal layers are grown by the semiconductor processes. The metal layer is applied as the layout of the connecting lines of the elements in the circuit. There are many isolation layers among the metal layers, such as: the first isolation layer 31, the second isolation layer 32, the third isolation layer 33, and the fourth isolation layer, etc., those of which are applied as the electric isolation of the metal layers, that is, there is no electric conduction between each metal layer. The end point of the said circuit element is usually connected to the first metal layer 21 for the usage of circuit layout. Since the functions required by consumers are increased so rapidly that the size of the circuit becomes very gigantic, so the number of the circuit elements is often accumulated to million units and it is impossible for human labor to complete them one by one. To speed the design procedure, a modularization method is usually adopted, that is, the regular used elements are assembled to a fixed formation in advance and directly put into usage during the design procedure without repetitious design. This kind of assembly is called as intellectual property (IP) or silicon IP. One thing must be pointed out: since IP means intellectual property so, in the IC industry, the IC design is an IP with specific function, which is completed through many design and verification steps. Because the number of the IC element is so gigantic that its connecting lines are very complicated, so it is impossible for human labor to connect them one by one, and a design software based on layout algorithm is usually used instead. When a circuit design is needed for modification, it has to get around these complicated connecting lines. Since increasing new connecting line is more difficult than cutting off the original connecting line, so increasing new connecting line will be mainly described herein.

Please refer to FIG. 2 again. The standard IC elements according to this embodiment includes four metal layers: the first metal layer 21, the second metal layer 22, the third metal layer 23, and the fourth metal layer 24. Generally, only the first metal layer 21 will be used in the layout of a standard cell, but based upon the requirement of circuit debug or design change, it is often necessary to connect the node point X (11) to the node point Y (12). However, the first metal layer 21 and the second metal layer 22 have already used by other connecting lines 41, 42, so it is impossible to reach the objective by direct connection, and other metal layers must be used instead, but the third metal layer 23 is also used by the connecting line 43 so, as shown in the figure, rounding routes have to be found out from up to down to achieve the connection objective. Please notice that the connecting lines, of this embodiment, stopping the connection between the node point X (11) and the node point Y (12), are only illustrative; in practice, the connecting lines between the first metal layer 21 and the second metal layer 22 are very complicated, such that it is impossible to connect the node point X (11) and the node point Y (12) directly.

Therefore, each metal layer must be used to reach the objective of connecting the node point X (11) and node point Y (12). During circuit design, the connecting line starts from the node point X of the first metal layer 21, through the second metal layer 22, the third metal layer 23, down to the second metal layer 22 again, and finally is connected to the first metal layer of the node point Y. However, in actual production, it must change the photo mask to change the routes of the integrated circuit. More, since the metal layers are isolated from each other, so the isolation layer must be drilled a hole called “via” between two layers to continue the connection. According to this kind of design, it is necessary to change five layers of the masks: the first metal layer 21, the via 51 between the first metal layer 21 and the second metal layer 22, the second metal layer 22, and the via 52 between the second metal layer 22 and the third metal layer 23, and the third metal layer 23. The charging rate of the wafer manufacture is based upon the changing number of the mask, and it takes about NT$ 500,000 per each mask's change. According to aforementioned embodiment, it will take NT$ 2,500,000 to change 5 masks just for increasing one connecting line. What a cost! It also takes a lot of time to design the layout and reproduce the mask and the line. Therefore, a new method must be found out to reduce production time and cost and enhance competitiveness.

### SUMMARY OF THE INVENTION

The main objective of the invention is to provide a method and software for automatic designing IC layout.

The secondary objective of the invention is to provide a method and software for automatically designing IC layout that may make least changes when the layout is changed.

The further objective of the invention is to provide a method and software for automatically designing IC layout to reduce research cost and time.

The further objective of the invention is to provide a method and software for automatically designing IC layout to enhance the flexibility of IC design.

To achieve above mentioned objectives, the invention provides a IC layout design method, wherein the IC includes a substrate including plural circuit devices, m levels of metal layer arranged on the substrate and functioned as inter connection lines of circuit devices, and a plurality of isolation layers respectively formed on said m levels of metal layer for electrical isolation. The method includes following steps:

Choosing a plurality of end points of IC devices.

Automatically laying out said plurality of end points of IC devices, making said plurality of end points of IC devices connect to n levels of metal layer, and n>1.

Furthermore, the invention also provides an IC layout design software that at least includes a function of automatically connecting a plurality of metal layers, making each end point of a plurality of IC devices connect to n levels of metal layer, and n>1.

### BRIEF DESCRIPTION OF THE DRAWINGS

FIG. 1 is a design flowchart of an integrated circuit.

FIG. 2 is a circuit's modifying illustration of a traditional integrated circuit.

FIG. 3 is a method's flowchart according to the invention.

FIG. 4 is an embodiment according to the invention.

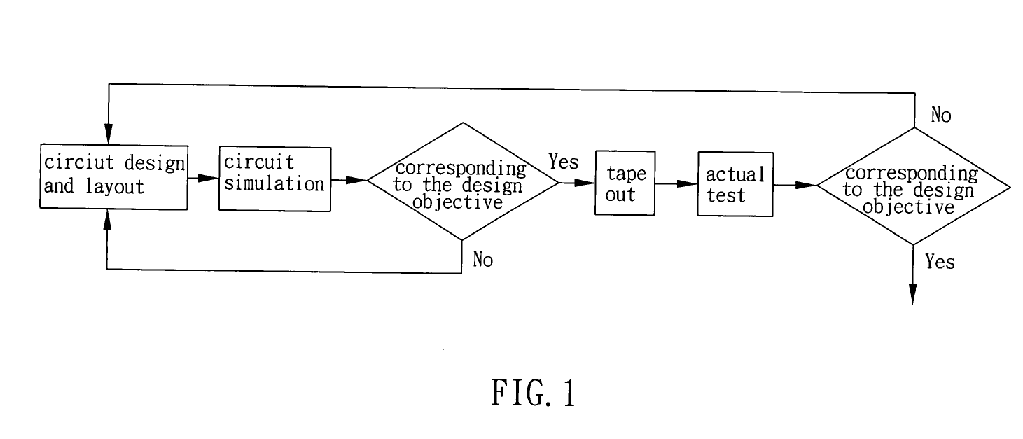

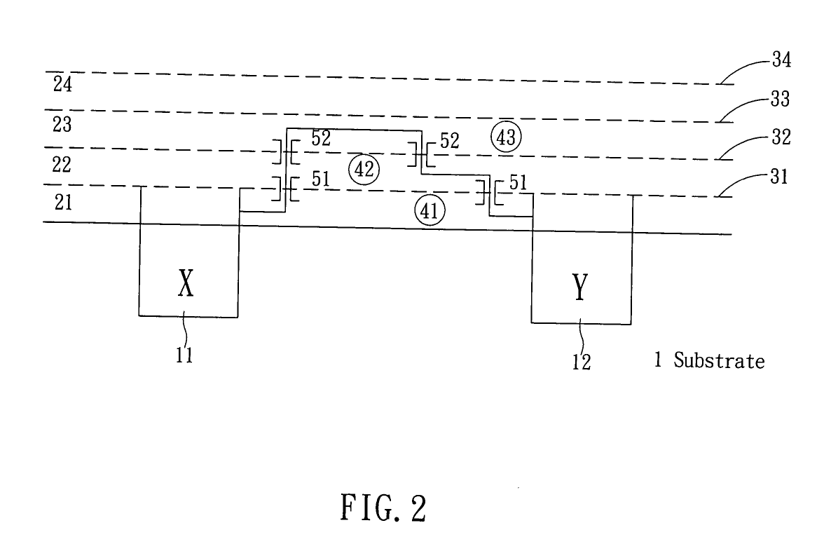

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

The major spirit of the invention is that, during two phases of circuit design-and-layout and circuit simulation, an IC's layout design method and layout design software- having the capability of automatic layout may make a user choose the end points of the elements in a circuit to connect plural layers of metal layer.

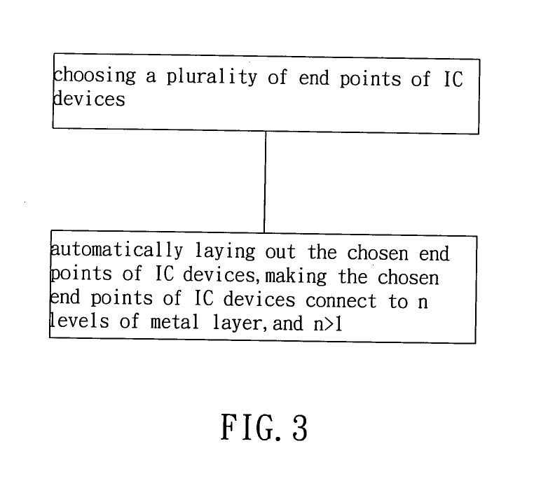

Please refer to FIG. 3, which is a method flowchart according to the present invention. The present invention is applied in an integrated circuit that includes a substrate comprising a plurality of devices, m levels of metal layer formed on the substrate and functioned as inter connection layout of devices, and a plurality of isolation layers respectively formed on the said m levels of metal layer for electrical isolation. The method according to the invention includes following steps:

Choosing the end points of a plurality of IC devices that can be all or the partial end points of all the IC devices, depending upon needs of the users;

Automatically laying out the plural chosen end points of the IC devices, making said plurality of end points of IC devices connect to n levels of metal layer; wherein n>1 and the n layers of metal layer are counted from the substrate; in other words, if n=2, the 1^{st} and 2^{nd} metal layers are connected; if n=3, the 1^{st}, 2^{nd}, and 3^{rd} metal layers are connected; if n=4, then the 1^{st}, 2^{nd}, 3^{rd}, 4^{th} metal layers are connected, and so on. In a preferred embodiment, the value of n may be assigned by users, and in another preferred embodiment, the value of n may be a predetermined value.

The method according to the invention may be executed in one formation or the integral formation of the software, hardware, and firmware, etc. In the software application, the present invention also provides an IC layout design software, and wherein the IC includes a substrate comprising a plurality of devices, m levels of metal layer formed on the substrate and functioned as inter connection layout of devices, and a plurality of isolation layers respectively formed on said m levels of metal layer for electrical isolation. This software at least includes a function of automatically connecting a plurality of metal layers, making each end point of a plurality of IC devices connect to n levels of metal layer, wherein n>1. Similarly, nmay be assigned by users or a predetermined value. In a preferred embodiment, the chosen end point of the circuit may be unable to be connected for some reasons, such as that the predetermined position have already been used for layout. At this time, this end point may be given up for connecting the n layers of metal layer, and two options of “no-action” and “connect as possible as it can” may take the place of it.

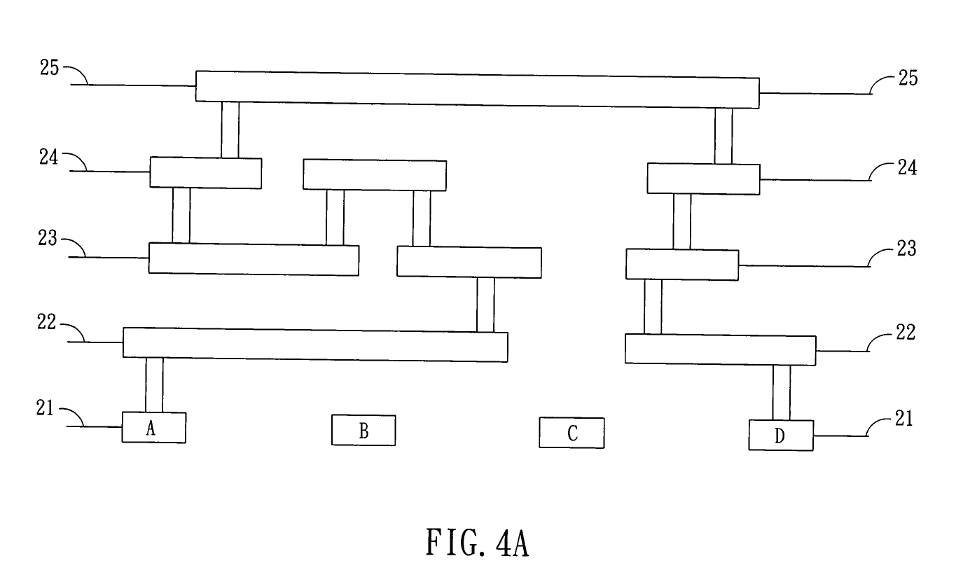

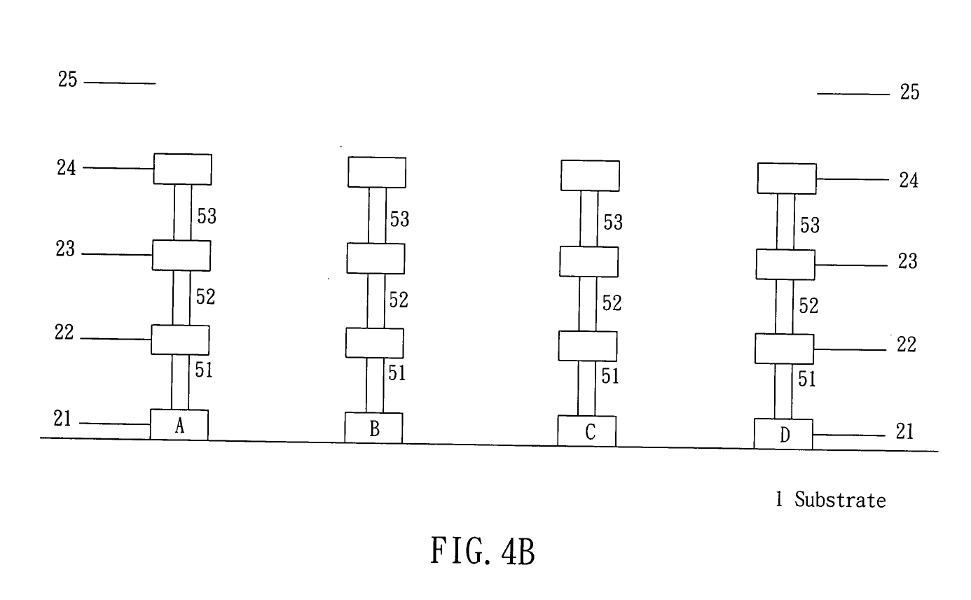

Please refer to FIG. 4A and 4B, showing another embodiment of the present invention and comparing the present invention to the traditional connection method. In this embodiment, there are total five levels of metal layer in an integrated circuit. As shown in FIG. 4A, four device end points A, B, C, D are provided. If the end points A, D are desired to be connected, the traditional method will try to find out the routes between each metal layer from up to down chaotically thus reducing the readability of the layout and increasing the difficulty of modification. Please refer to FIG. 4B, which shows a more feasible embodiment with the present invention. During the designing, the four device end points A, B, C, D are chosen and the four levels of metal layer are chosen as well, then the configuration shown in FIG. 4B will thus be formed. At this time, the end point A is connected to the end point D manually or automatically (there is no connecting line shown in the figure) thus completing the design objective. In another embodiment, one metal layer can even be reserved particularly for the future modification (e.g., the fifth metal layer 25) so as to obtain the balance between the easy modification and the least change of the number of the photo masks. The lower and unmodified layers are produced in advance in order to save the manufacturing time. In another embodiment, if the position for the end point B in the third metal layer 23 has been already used, the end point B will only connect to the second metal layer instead of the fourth metal layer.

In applying the layout design method and the layout design software according to the invention, the first advantage is the enhancement of the layout flexibility. Since the chosen circuit device end points already had the corresponding positions in each n metal layer, the connecting lines are simply used to connect the n metal layers with the said positions corresponding to the end points without concerning the limitation of must-connect-first-metal-layer, and hence, further increase the flexibility of layout. Second, it is possible to increase the readability of the layout. Because all the n metal layers have end points available for line connection, the situation of chaotically rounding up and down during the process of layout thus can be greatly reduced. It reduces the effort on the maintenance and the modification afterwards. Thirdly, since the layout modification of the circuit can be constrained within certain metal layers, particularly within one specific metal layer, the objective of circuit modification can be easily achieved by only changing the particular masks thus saving significant time and cost.

In summary, when the invention is applied in the two phases of IC's circuit design-and-layout and the circuit simulation, users may freely assign all or the partial end points of the devices in the integrated circuit to connect plural metal layers by this manner of automatic layout. In such a way, it is only necessary to make the connection lines connect the end points in the certain metal layer without connecting to the first metal layer. Moreover, circuit modification can be achieved more easily and time and cost saving.

However, the aforementioned description is only the preferable embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

1. A method for automatically designing IC layout, including following steps:
choosing plural end points of IC devices; and
automatically laying out said plural end points of IC devices, making said plural end points of IC devices connect to n levels of metal layer, and n>1;
wherein the IC includes a substrate comprising plural devices, m levels of metal layer formed on the substrate and functioned as inter connection of the devices, and a isolation layer formed in between each metal layers for electrical isolation.

2. The method for automatically designing IC layout according to claim 1, wherein includes all end points of the IC devices.

3. The method for automatically designing IC layout according to claim 1, wherein the value of n can be assigned by a user.

4. The method for automatically designing IC layout according to claim 1, wherein the value of n can be a predetermined value.

5. The method for automatically designing IC layout according to claim 1, wherein the method can be applied in any one of the software, hardware, and firmware.

6. A software for automatically designing IC layout, including:
a function automatically connects plural metal layers, making each end point of IC devices connect to n levels of metal layer, and n>1;
wherein the IC includes a substrate comprising plural devices, m levels of metal layer formed on the substrate and functioned as inter connection of the devices, and a isolation layer formed in between each metal layers for electrical isolation.

7. The software for automatically designing IC layout according to claim 6, wherein includes all end points of the IC devices.

8. The software for automatically designing IC layout according to claim 6, wherein the value of n can be assigned by a user.

9. The software for automatically designing IC layout according to claim 6, wherein the value of n can be a predetermined value.

10. A method for automatically designing IC layout, including following steps:
automatically laying out said plural end points of IC devices, making said plural end points of IC devices connect to n levels of metal layer, and n>1;
wherein the IC includes a substrate comprising plural devices, m levels of metal layer formed on the substrate and functioned as inter connection of the devices, and a isolation layer formed in between each metal layers for electrical isolation.

11. The method for automatically designing IC layout according to claim 10, wherein includes all end points of the IC devices.

12. The method for automatically designing IC layout according to claim 10, wherein the value of n can be assigned by a user.

13. The method for automatically designing IC layout according to claim 10, wherein the value of n can be a predetermined value.

14. The method for automatically designing IC layout according to claim 10, wherein the method can be applied in any one of the software, hardware, and firmware.
